(19) United States
(12) Patent Application Publication
(10) Pub. No.: US 2011/0079465 A1
(43) Pub. Date: Apr. 7, 2011

(54) Multi-Fit Stairway Hook

(75) Inventor: Rached Karanouh, Strongsville, OH (US)

(73) Assignee: WACO INTERNATIONAL CORPORATION, Cleveland, OH (US)

(21) Appl. No.: 12/573,427

(22) Filed: Oct. 5, 2009

(51) Int. Cl. E04G 7/02; E04G 1/00; E04G 5/10; E04G 7/00; B23P 11/00

(52) U.S. Cl. 182/115; 403/49; 29/525.01

(57) ABSTRACT

An architecture is presented that consolidates scaffold stair units to one unit with a multi-fit hook device. The multi-fit hook device for scaffolding comprises a bracket with an opening at one end. The bracket further comprises slotted holes formed in the bracket, outside the opening to aid in securing the multi-fit hook device to an access way. Hardware, such as screws or bolts, is inserted through the slotted holes to secure the bracket to the access way. The opening at one end of the bracket is formed to accept scaffold tubing indeterminate of size, and can be used on any scaffold system. Thus, the opening is not scaffold tube style specific and does not require a separate unit for each scaffold system. Instead, the multi-fit hook device permits the same access way to be used on multiple scaffold systems.

### BACKGROUND

As is well known in the building industry, scaffolding is virtually always employed during various facets of exterior and/or interior building construction or refurbishment. Known scaffolding systems typically comprise steel support frame structures which are selectively engageable to each other in a stacked fashion for achieving a desired overall height. Specifically, conventional scaffolds ordinarily comprise a plurality of vertical posts which are connected by cross-braces and which may be stacked on top of each other. Connection hooks are in particularly great demand for the construction of scaffoldings in order to be able to securely and quickly releasably connect scaffolding frames with one another, platforms, spars, reinforcements and other scaffolding elements, in particular for scaffoldings consisting of pre-manufactured elements.

Devices for accessing or mounting a scaffold platform generally consists of ladders or stair units, added onto the structure of the scaffold structure. A stair unit can be used in prefabricated sectional scaffolding of the type employing standardized frame sections which may be interconnected to form a rigid structure of the desired size. As connection hooks are tube style specific, a separate stair unit is needed for each specific tube style. A multi-fit hook would give a user the ability to use the same stair unit on frame scaffold and system scaffold without being tube style specific.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a multi-fit hook device for scaffolding that comprises a bracket. The bracket further comprises an opening at one end that is configured to accept scaffold tubing. The opening is configured to accept scaffold tubing indeterminate of size, and can be used on any scaffold system. Thus, the opening is not scaffold tube style specific and does not require a separate unit for each scaffold system. Instead, the multi-fit hook device permits the same access way to be used on multiple scaffold systems.

Furthermore, slotted holes are formed in the bracket, outside the opening to aid in securing the multi-fit hook device to an access way. Hardware, such as screws or bolts, is inserted through the slotted holes to secure the bracket to the access way. Additionally, force can be applied to the bracket which causes the hardware to slide in the slotted holes, and which slides the access way against the bracket, allowing for adjustability in length of the access way. This accommodates scaffold systems of varying heights.

Further, the movement of the access way against the bracket can also position the access way directly against the scaffold tubing to clamp or lock the access way to the scaffold tubing. Then, the hardware which is passed through the slotted holes is torqued to secure the bracket to the access way and retain the access way locked against the scaffold tubing. Typically, a bracket can also be positioned on opposing sides of the access way to further secure the access way to the scaffolding system.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a planar view of a multi-fit hook device.

FIG. 2 illustrates a planar view of the scaffolding system wherein the multi-fit hook device is engaging the scaffold tubing and the bracket is secured to the access way.

FIG. 3 illustrates a planar view of the scaffolding system wherein the multi-fit hook engages scaffold tubing having an outside diameter of 1 and ⅝ inches.

FIG. 4 illustrates a planar view of the scaffolding system wherein the multi-fit hook engages scaffold tubing having an outside diameter of 1.90 inches.

FIG. 5 illustrates a planar view of the scaffolding system wherein the multi-fit hook engages scaffold tubing having an outside diameter of 1.69 inches.

FIG. 6 illustrates a method of securing an access way to a scaffolding system.

FIG. 7 illustrates further aspects in the securing method of FIG. 6.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Typically, stair units are prefabricated and employ standardized frame sections which are interconnected to form a rigid structure. As connection hooks are tube style specific, a separate stair unit is needed for each specific tube style or scaffolding system. A multi-fit hook would give a user the ability to use the same scaffolding stair unit on frame scaffold and system scaffold without being tube style specific.

Accordingly, the device consolidates scaffold stair units to one unit with a multi-fit hook device. The multi-fit hook device for scaffolding comprises a bracket with an opening at one end formed to accept scaffold tubing indeterminate of size. Thus, the opening is not scaffold tube style specific and does not require a separate unit for each scaffolding system. Instead, the multi-fit hook device permits the same access way (or stair unit) to be used on multiple scaffold systems.

Referring initially to the drawings, FIG. 1 illustrates a multi-fit hook device 100 for scaffolding that comprises a bracket 102. The bracket 102 comprises an opening 104 at one end that is formed to accept scaffold tubing (not shown). The opening 104 is typically hook-shaped with an inside diameter configured to accept scaffold tubing. The opening 104 is formed to accept scaffold tubing indeterminate of size, and can be used on any scaffold system. Specifically, the opening 104 is formed to accept scaffold tubing having an outside diameter of 1 and ⅝ inches, 1.90 inches or 1.69 inches. Thus, the opening 104 is not scaffold tube style specific and does not require a separate unit for each scaffold system. Instead, the multi-fit hook device 100 permits an access way to be used on multiple scaffold systems, (e.g., Waco® Scaffolding & Equipment Company, Wedgelok® or Millennium® Scaffold System).

Furthermore, slotted holes 106 are formed in the bracket 102, outside the opening 104 to aid in securing the multi-fit hook device 100 to an access way. Typically, there are two slotted holes 106 positioned on the bracket 102, however any number of slotted holes 106 can be formed in the bracket 102. Hardware, such as screws or bolts, are inserted through the slotted holes 106 to secure the bracket 102 to the access way. Additionally, the multi-fit hook device 100 is burned from hot rolled steel.

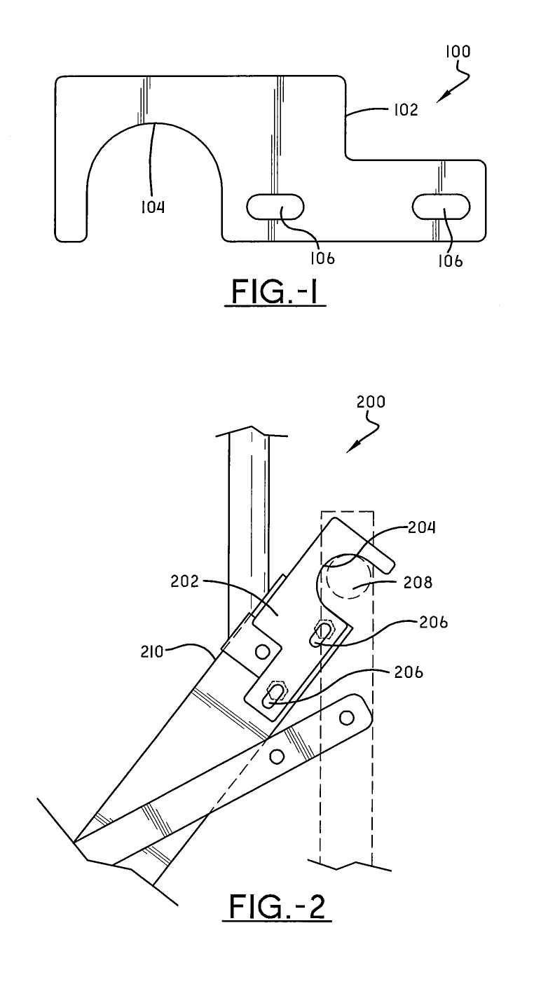

In more detail, FIG. 2 illustrates a scaffolding system 200 comprising a bracket 202 secured to an access way 210. The bracket 202 comprises a hook-shaped opening 204 at one end that is formed to accept scaffold tubing 208. The opening 204 is formed to accept scaffold tubing 208 indeterminate of size, and can be used on any scaffold system. Thus, the opening 204 is not scaffold tube style specific and does not require a separate unit for each scaffold system 200.

Furthermore, slotted holes 206 are formed in the bracket 202, outside the opening 204 to assist in securing the access way 210 to the bracket 202. Hardware, such as screws or bolts, is inserted through the slotted holes 206 to secure the bracket 202 to the access way 210. Additionally, force can be applied to the bracket 202 which causes the hardware to slide in the slotted holes 206, and which slides the access way 210 against the bracket 202, allowing for adjustability in length of the access way 210. Adjusting the length of the access way 210 allows for longer or shorter distances between the point of attachment of the opening 204 formed in the bracket 202 and the terminating point of the access way 210. This accommodates scaffold systems of varying heights. For example, the bracket 202 and opening 204 can accommodate a scaffold system having a lift or height of 6′ 7″ or a scaffold system having a lift or height of 6′ 6¾″.

The movement of the access way 210 against the bracket 202 can also position the access way 210 directly against the scaffold tubing 208 to clamp or lock the access way 210 to the scaffold tubing 208. Then, the hardware which is passed through the slotted holes 206 is torqued to secure the bracket 202 to the access way 210 and retain the access way 210 locked against the scaffold tubing 208. Typically, a bracket 202 can be positioned on opposing sides of the access way 210 to further secure the access way 210 to the scaffolding system 200.

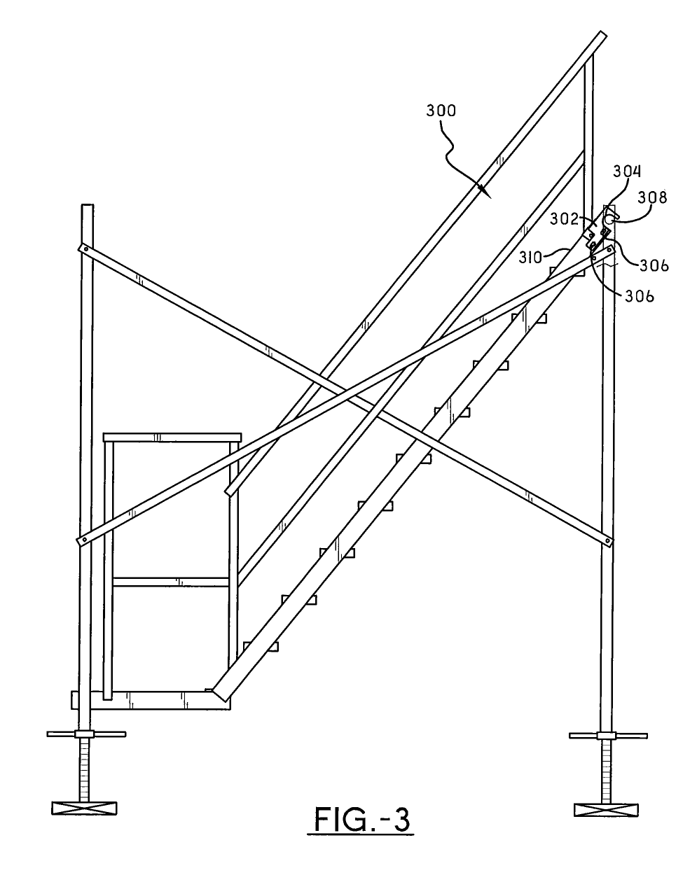

Furthermore, FIG. 3 illustrates a scaffolding system 300 wherein the multi-fit hook device engages scaffold tubing 308 having an outside diameter of 1 and ⅝ inches. Specifically, bracket 302 of the multi-fit hook device is secured to an access way 310. The bracket 302 comprises a hook-shaped opening 304 at one end that is formed to accept scaffold tubing 308 indeterminate of size, and that can be used on any scaffold system. For example in FIG. 3, the scaffold tubing 308 shown has an outside diameter of 1 and ⅝ inches and is shown in conjunction with the Frame Scaffold and System Scaffold. However, the opening 304 is also formed to accept scaffold tubing having an outside diameter of 1 and ⅝ inches, 1.90 inches or 1.69 inches. Thus, the opening 304 permits the same access way 310 to be used on multiple scaffold systems, (e.g., Frame Scaffold and System Scaffold, Wedgelok® Scaffold or Millennium® Scaffold).

Further, slotted holes 306 are formed in the bracket 302, outside the opening 304 to assist in securing the access way 310 to the bracket 302. Hardware, such as screws or bolts, is inserted through the slotted holes 306 to secure the bracket 302 to the access way 310. Additionally, force can be applied to the bracket 302 which causes the hardware to slide in the slotted holes 306, and which slides the access way 310 against the bracket 302, allowing for adjustability in length of the access way 310. This accommodates scaffold systems of varying heights. For example, the bracket 302 and opening 304 can accommodate a scaffold system having a height of 6′ 7″ or a scaffold system having a height of 6′ 6¾″.

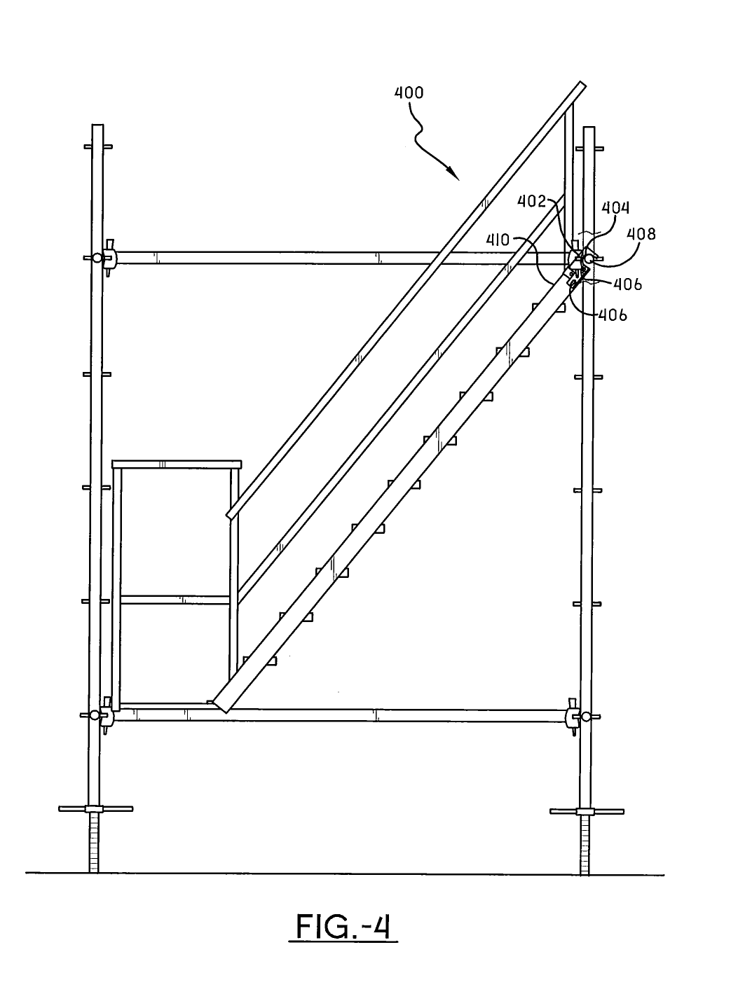

Furthermore, FIG. 4 illustrates a scaffolding system 400 wherein the multi-fit hook device engages scaffold tubing 408 having an outside diameter of 1.90 inches. Specifically, bracket 402 of the multi-fit hook device is secured to an access way 410. The bracket 402 comprises a hook-shaped opening 404 at one end that is formed to accept scaffold tubing 408 indeterminate of size, and that can be used on any scaffold system. For example in FIG. 4, the scaffold tubing 408 shown has an outside diameter of 1.90 inches and is shown in conjunction with the Millennium® Scaffold System. However, the opening 404 is also formed to accept scaffold tubing having an outside diameter of 1 and ⅝ inches, 1.90 inches or 1.69 inches. Thus, the opening 404 permits the same access way 410 to be used on multiple scaffold systems.

Further, slotted holes 406 are formed in the bracket 402, outside the opening 404 to assist in securing the access way 410 to the bracket 402. Hardware, such as screws or bolts, is inserted through the slotted holes 406 to secure the bracket 402 to the access way 410. Additionally, force can be applied to the bracket 402 which causes the hardware to slide in the slotted holes 406, and which slides the access way 410 against the bracket 402, allowing for adjustability in length of the access way 410. This accommodates scaffold systems of varying heights, such as scaffold systems having a height of 6′ 7″ or a height of 6′ 6¾″.

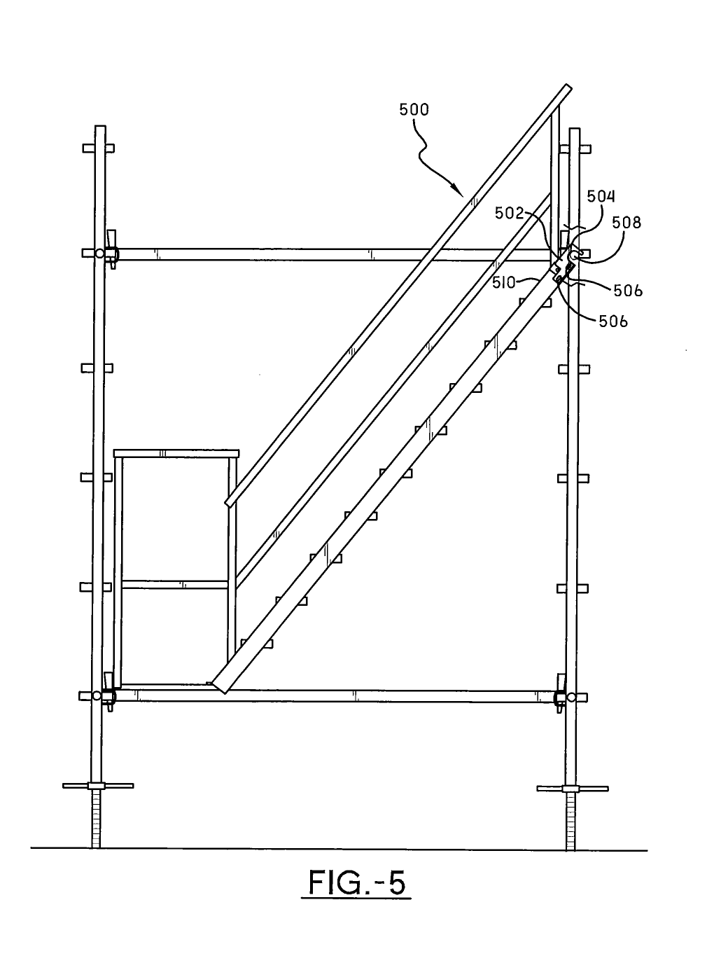

FIG. 5 illustrates a scaffolding system 500 wherein the multi-fit hook device engages scaffold tubing 508 having an outside diameter of 1.69 inches. Specifically, bracket 502 of the multi-fit hook device is secured to an access way 510. The bracket 502 comprises a hook-shaped opening 504 at one end that is formed to accept scaffold tubing 508 indeterminate of size, and that can be used on any scaffold system. For example in FIG. 5, the scaffold tubing 508 shown has an outside diameter of 1.69 inches and is shown in conjunction with the Wedgelok® Scaffold System. However, the opening 504 is also formed to accept scaffold tubing having an outside diameter of 1 and ⅝ inches, 1.90 inches or 1.69 inches. Thus, the opening 504 permits the same access way 510 to be used on multiple scaffold systems.

Further, slotted holes 506 are formed in the bracket 502, outside the opening 504 to assist in securing the access way 510 to the bracket 502. Hardware, such as screws or bolts, is inserted through the slotted holes 506 to secure the bracket 502 to the access way 510. Additionally, force can be applied to the bracket 502 which causes the hardware to slide in the slotted holes 506, and which slides the access way 510 against the bracket 502, allowing for adjustability in length of the access way 510. This accommodates scaffold systems of varying heights.

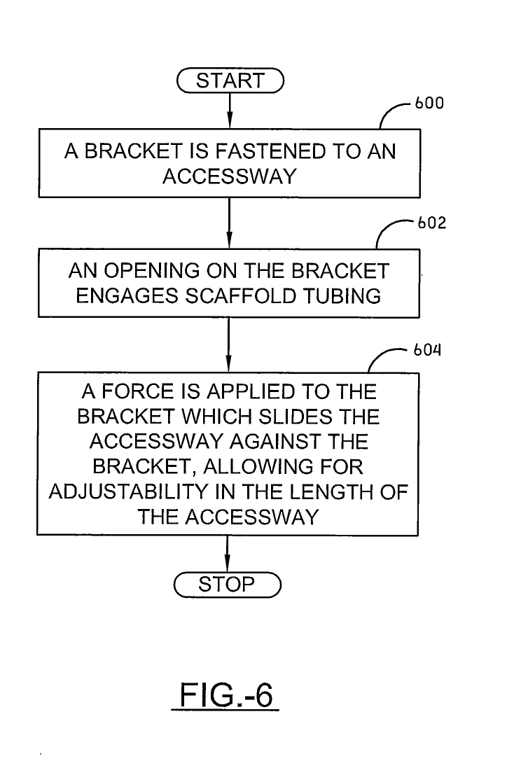

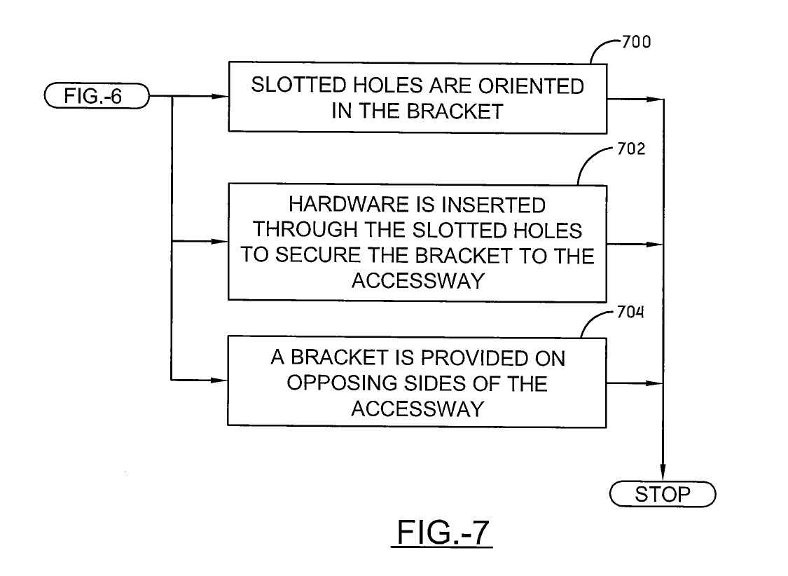

FIGS. 6-7 illustrate methodologies of securing an access way to a scaffolding system, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 6, a method of securing an access way to a scaffolding system is illustrated. At 600, a bracket is fastened to an access way. Slotted holes are formed in the bracket, outside the opening to aid in securing the bracket to an access way. Typically, there are two slotted holes positioned on the bracket, however any number of slotted holes can be formed in the bracket. Hardware, such as screws or bolts, are inserted through the slotted holes to secure the bracket to the access way.

At 602, an opening on the bracket engages scaffold tubing. The bracket comprises an opening at one end that is formed to accept scaffold tubing. The opening is typically hook-shaped with an inside diameter configured to accept scaffold tubing. The opening is formed to accept scaffold tubing indeterminate of size, and can be used on any scaffold system. Specifically, the opening is formed to accept scaffold tubing having an outside diameter of 1 and ⅝ inches, 1.90 inches or 1.69 inches. Thus, the opening is not scaffold tube style specific and does not require a separate unit for each scaffold system. Instead, the opening permits the same access way to be used on multiple scaffold systems, (e.g., Waco® Scaffolding & Equipment Company, Wedgelok® or Millennium® Scaffold System).

And, at 604 a force is applied to the bracket which slides the access way against the bracket, allowing for adjustability in length of the access way. This accommodates scaffold systems of different heights. For example, the scaffolding stair system accommodates a scaffolding having a lift or height of 6 foot 7 inches or a lift or height of 6 foot 6 and ¾ inches. Further, the movement of the access way against the bracket can also position the access way directly against the scaffold tubing to clamp or lock the access way to the scaffold tubing. Then, the hardware which is passed through the slotted holes is torqued to secure the bracket to the access way and retain the access way locked against the scaffold tubing.

FIG. 7 illustrates further aspects in the securing method of FIG. 6. At 700, slotted holes are oriented in the bracket. Specifically, slotted holes are formed in the bracket, outside the opening to aid in securing the bracket to an access way. Typically, there are two slotted holes positioned on the bracket, however any number of slotted holes can be formed in the bracket. At 702, hardware is inserted through the slotted holes to secure the bracket to the access way. Hardware, such as screws or bolts, is inserted through the slotted holes to secure the bracket to the access way.

And at 704, a bracket is provided on opposing sides of the access way. Typically, a bracket can be positioned on opposing sides of the access way to assist in securing the access way to the scaffolding system.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-fit hook device for scaffolding, comprising:
a bracket with an opening at one end that is formed to accept scaffold tubing of varying size; and
slotted holes formed in the bracket, outside the opening to secure the bracket to an access way.

2. The multi-fit hook device of claim 1, wherein the opening formed at one end of the bracket is hook-shaped with an inside diameter configured to accept scaffold tubing of varying size.

3. The multi-fit hook device of claim 1, wherein hardware is passed through the slotted holes to fasten the bracket to the access way.

4. The multi-fit hook device of claim 1, wherein there are two slotted holes in the bracket.

5. The multi-fit hook device of claim 4, wherein the slotted holes are secured by screws.

6. The multi-fit hook device of claim 1, wherein there is a bracket positioned on opposing sides of the access way.

7. The multi-fit hook device of claim 1, wherein the scaffold tubing has an outside diameter between 1.58 inches and 1.68 inches.

8. The multi-fit hook device of claim 1, wherein the scaffold tubing has an outside diameter between 1.85 inches and 1.95 inches.

9. The multi-fit hook device of claim 1, wherein the scaffold tubing has an outside diameter of 1.63 inches and 1.74 inches.

10. A method of securing an access way within a scaffolding, comprising:
fastening a bracket to an access way;
engaging scaffold tubing of indeterminate size via an opening on the bracket; and
applying a force to the bracket which slides the access way against the bracket, allowing for adjustability in length of the access way.

11. The method of claim 10, further comprising:
orienting slotted holes in the bracket; and
inserting hardware through the slotted holes to secure the bracket to the access way.

12. The method of claim 11, wherein there are two slotted holes in the bracket.

13. The method of claim 11, further comprising providing a bracket on opposing sides of the access way.

14. The method of claim 10, wherein the scaffold tubing has an outside diameter between 1.58 inches and 1.68 inches.

15. The method of claim 10, wherein the scaffold tubing has an outside diameter between 1.85 inches and 1.95 inches.

16. The method of claim 10, wherein the scaffold tubing has an outside diameter between 1.63 inches and 1.74 inches.

17. A scaffolding stair system, comprising:
a bracket with a hook-shaped opening formed to accept scaffold tubing of varying size;
at least two slotted holes formed in the bracket, outside the hook-shaped opening;
an access way fastened to the bracket; and
hardware passed through the at least two slotted holes to secure the bracket to the access way.

18. The system of claim 17, wherein force applied to the bracket slides the access way against the bracket allowing for adjustability in length of the access way.

19. The system of claim 18, wherein the scaffolding stair system accommodates a scaffolding having a height of 6 foot 7 inches or a height of 6 foot 6 and ¾ inches.

20. The system of claim 17, wherein the scaffold tubing comprises an outside diameter of at least one of 1 and ⅝ inches, 1.90 inches or 1.69 inches.
